(19) United States
(12) Patent Application Publication
(10) Pub. No.: US 2025/0267003 A1
(43) Pub. Date: Aug. 21, 2025

(54) PRIVACY-PRESERVING HEALTH VERIFICATION SYSTEM WITH INCENTIVE MECHANISM FOR REGULAR TESTING

(71) Applicant: STD VERIFY, SPC, San Francisco, CA (US)

(72) Inventor: Austin Shane Harshberger, San Francisco, CA (US)

(73) Assignee: STD VERIFY, SPC, San Francisco, CA (US)

(21) Appl. No.: 19/200,691

(22) Filed: May 7, 2025

(51) Int. Cl. H04L 9/32; H04L 9/40

(52) U.S. Cl. CPC H04L 9/3221; H04L 63/04

(57) ABSTRACT

A privacy-preserving health verification system with incentive mechanisms for promoting regular testing behavior is disclosed. The system implements a cryptographic separation between user identity and verification status by extracting minimal verification metadata from health documentation and generating zero-knowledge proofs. Pseudonymous identifiers eliminate direct linkages between identity and health status while maintaining verification integrity. An algorithmic incentive mechanism analyzes temporal patterns between verification events, implementing streak detection with configurable grace periods and recovery acceleration factors. The system enables secure verification sharing with third parties through cryptographically signed, time-limited tokens containing no personally identifiable information. The implementation simultaneously solves privacy challenges and psychological barriers to regular testing, delivering a viable solution for improved testing schedules and enhanced compliance with recommended health protocols, particularly in sensitive health domains such as sexually transmitted diseases and infections.

### FIELD OF THE INVENTION

This invention relates to digital health verification systems, specifically a privacy-preserving platform that enables health testing status verification without exposing underlying medical information, facilitates secure sharing of verification status with authorized third parties, and incorporates behavioral incentive mechanisms to promote regular testing patterns.

### BACKGROUND OF THE INVENTION

Regular sexually transmitted disease (STD) testing is critical for public health, especially in communities with higher transmission rates. According to the Centers for Disease Control and Prevention (CDC, 2018), approximately 20% of Americans are living with an STI, with 26 million new infections occurring each year. The impact of STIs is particularly severe among men who have sex with men (MSM), who accounted for 68% of all new HIV diagnoses in 2022 (HIV.gov, 2022). Additionally, LGBTQ+youth face barriers to care due to stigma and institutional distrust. Several technical and psychological barriers prevent optimal testing frequency:

Privacy Concerns: Current systems require storing sensitive medical data either on central servers with little privacy guarantees or distributed ledgers where the lack of privacy is a feature.

Trust and Verification Challenges: Self-reporting lacks reliable verification. Without cryptographic proof, test authentication, or tamper-evident records, users must rely solely on each other.

Lack of Motivation: With no computational reward mechanisms, gamification elements, or streak-tracking algorithms to reinforce positive patterns, users lack incentive to test regularly.

Fragmented Ecosystem: No standardized solution exists for health verification across platforms while maintaining privacy. Current systems lack interoperability, forcing proprietary implementations that create inconsistent experiences and increased privacy risks.

Psychological Barriers: Stigma and anxiety surrounding testing create significant psychological resistance thereby reducing testing frequency.

Previous attempts to address these challenges have been inadequate:

Dating platforms such as those disclosed in U.S. Pat. No. 7,246,067 to Austin et al., offer verification features that lack automation, incentivization, and store data centrally providing little or no privacy guarantees.

Existing health incentive systems like those described in U.S. Pat. No. 8,719,056 to Bartley et al., store personal data in an immutable ledger, creating direct linkages between identity and health activities.

Current credential verification and licensing services rely on labor-intensive human review or distributed processes without privacy assurances or they require submission of complete medical records (ECFM G, 2023; U.S. Patent Application Publication No. 2015/0278824 to Zabar; U.S. Pat. No. 10,679,151 to Mahalingam et al.).

Blockchain health record systems such as the one disclosed in U.S. Pat. No. 10,340,038 to Witchey, store medical data on distributed ledgers, “chronicling a person's healthcare path through life,” prioritizing provenance and full disclosure over the selective disclosure capabilities needed for privacy-preserving verification.

This invention introduces a privacy-preserving verification system using zero-knowledge proofs and behavioral incentives to promote regular testing. It addresses STI prevention by combining anonymous verification, and behavioral reinforcement in an interoperable design that cryptographically separates identity from verification status.

### BRIEF SUMMARY OF THE INVENTION

A privacy-preserving health verification platform is provided that mathematically guarantees confidentiality while enabling individuals to share testing status without revealing private medical records. The system establishes user identity through a one-time verification process, validates test documents, generates zero-knowledge proofs, deletes original documents, and incentivizes regular testing through points, achievements, and variable rewards.

This integrated system addresses both privacy concerns and behavioral barriers through synergistic components:

Identity Foundation & User Control: The system establishes trust through identity verification during onboarding, creating a cryptographically sealed profile that enables future pseudonymous operations while maintaining user control of verification sharing.

Document Analysis & Zero-Knowledge Verification: Using zkVM technology, the system verifies testing status without exposing results via a dual-processing approach that leverages OCR and NLP models trained specifically on large sets of medical records. Only minimally necessary metadata is extracted and the original document is permanently deleted. These systems, when combined with pseudonymous identifiers, cryptographically separate identity from verification status, ensuring no sensitive data remains after verification.

Algorithmic Incentivization: Behavioral algorithms promote regular testing through rewards that increase with engagement. Network effects amplify value through referrals and partner integrations as ecosystem growth increases verification utility.

Secure Verification Sharing: Cryptographically secure, time-limited tokens enable third-party verification using enhanced OAuth 2.0 protocols without exposing medical data.

Adaptive Streak Detection: Pattern recognition identifies and rewards consistent testing through temporal analysis algorithms while maintaining unlinkability.

Progressive Reward Mechanics: Variable reward strategies that are based on testing consistency maximize behavioral reinforcement. This approach uses scientifically validated variable-ratio schedules, applied through computational methods and logarithmic scaling functions for long-term engagement.

The novel combination of all these components simultaneously solves privacy challenges and psychological barriers to regular testing, delivering a viable solution for improved STI testing schedules and a new type of cryptographic health verification.

### DEFINITIONS

As used herein, the following terms shall have the following meanings:

“Zero-knowledge proof” refers to a cryptographic method by which one party can prove to another party that a given statement is true without conveying any additional information.

“Pseudonymous Identifier” refers to an artificial identifier that consistently represents a user within the system without revealing their actual identity, allowing for persistent recognition across multiple interactions while maintaining privacy and preventing correlation with the user's real-world identity.

“Partner SDK” refers to the Software Development Kit provided to third-party platforms that enables secure integration with the verification system, including pre-built libraries, documentation, and sample code for implementing verification status sharing while maintaining privacy protections.

“OAuth Enhancement” refers to the system's extension of the standard OAuth 2.0 protocol with additional privacy-preserving features, including fine-grained permission scopes, pseudonymous token issuance, and revocation capabilities with immediate effect.

“Double-Entry Points Ledger” refers to the accounting mechanism used to track point transactions, ensuring that all point awards, deductions, and transfers are recorded with both a debit and credit entry to maintain system integrity and enable audit capabilities.

“Multi-Factor Verification” refers to the document authentication process that simultaneously analyzes multiple aspects of submitted health documentation, including format consistency, security features, temporal consistency, and structural validation.

“Logarithmic Scaling Function” refers to the mathematical model used to determine point values for long-term engagement, implementing a decreasing rate of reward growth that maintains motivation while preventing system inflation.

“Variable Reward Schedule” refers to the behavioral reinforcement mechanism that implements unpredictable timing and magnitude of rewards based on scientific principles established by Ferster and Skinner (1957) to maximize engagement.

“Provider-Direct Submission” refers to the secure pathway allowing authorized healthcare providers to submit verification records directly to the system on behalf of users, increasing trust through professional verification while maintaining privacy.

“Cross-Platform Verification Token” refers to the cryptographically signed, time-limited authorization that enables verification status sharing across different platforms or contexts without revealing the underlying personal information.

“Network Effects” refers to the phenomenon where the value of the system increases for all participants as more users join the platform. As the user base grows, verification status becomes more widely recognized and accepted across partner platforms, creating a self-reinforcing cycle where increased adoption leads to greater utility for all users and partners in the ecosystem.

“White-Label Integration” refers to the capability for partner platforms to implement verification features with customized branding and user interface components while maintaining the underlying privacy and security mechanisms.

“zkVM” refers to a Zero-Knowledge Virtual Machine, a computational environment that enables the creation of zero-knowledge proofs for arbitrary computations.

“Trustless” refers to a system architecture that mathematically guarantees privacy and security through cryptographic mechanisms rather than requiring users to trust a central authority or organization with their sensitive information.

“Testing streak” refers to a consecutive series of verified health tests conducted within defined time intervals.

“Points ledger” refers to the transactional database system that records point earnings, deductions, and balances within the incentive system.

“Provider-verified” refers to test results submitted directly by authorized healthcare providers rather than uploaded by end-users.

“Verification status” refers to the cryptographically secured attestation that a user has completed valid health testing within a specified timeframe, linked to a profile with an immutably verified identity that was confirmed during initial document processing.

“Achievement badge” refers to a digital recognition awarded for specific testing behaviors or milestones.

“Streak protection” refers to mechanisms that maintain a user's consecutive testing record despite minor deviations from optimal testing schedules.

“OAuth” refers to the open standard for access delegation, commonly used for secure third-party authorization without sharing credentials.

“API” refers to Application Programming Interface, a set of defined rules for how software components interact.

### BRIEF DESCRIPTION OF THE DRAWINGS

The patent application includes the following figures:

FIG. 1 illustrates the system architecture of the privacy-preserving health verification system, showing the client layer, API gateway layer, core microservices layer, and database & storage layer.

FIG. 2 shows the process flow of the privacy-preserving verification mechanism, including user device, client processing, secure transmission, server processing, document verification, zero-knowledge proof generation, document deletion, and status assignment.

FIG. 3 depicts a flowchart of the points system algorithm for incentivizing regular testing behavior, showing test verification event, base points calculation, streak analysis, testing frequency, multiplier application, achievement evaluation, points award transaction, and notification engine.

FIG. 4 shows the verification sharing system architecture, illustrating the OAuth authorization flow, token generation, access control, and verification request/response components.

FIG. 5 depicts the multi-dimensional reward system structure, including point categories, achievement types, streak mechanics, and the relationship between behaviors and rewards.

FIG. 6 illustrates the database schema for each aspect of the system and the relationship between each table.

FIG. 7 illustrates the lifecycle of a ProfileID throughout the privacy-preserving health verification system, including initial account creation and verification events.

FIG. 8 depicts the user flow during account creation, identity verification, and sign-on process, showing the interaction between user actions and system processes, leading up to the verification process.

### DETAILED DESCRIPTION OF THE INVENTION

The present invention provides a comprehensive system for privacy-preserving health verification with integrated incentive mechanisms. Various embodiments of the invention will now be described in detail with reference to the accompanying drawings.

### System Overview and User Lifecycle

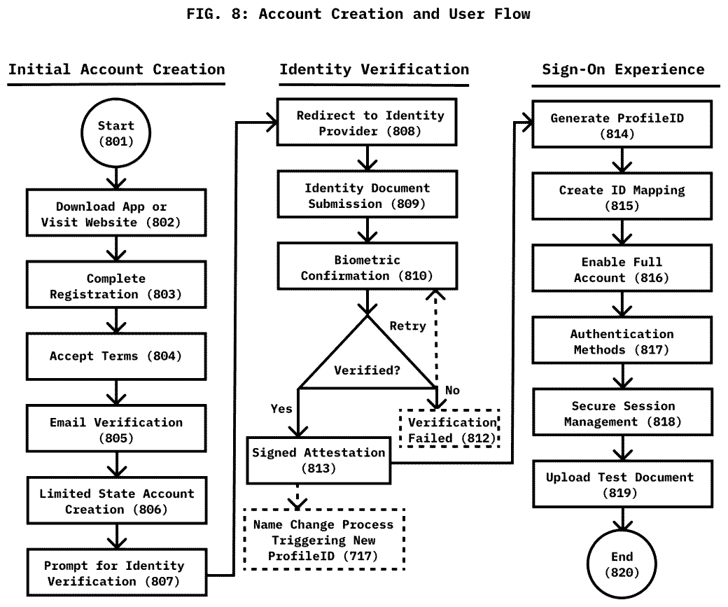

The system implements a user-centric verification platform that begins with account creation and extends through ongoing test verification and rewards. As shown in FIG. 8, the user journey consists of three key phases: initial account creation, identity verification, and the subsequent sign-on experience.

During initial account creation, as shown in FIG. 8, users download the application or visit the web platform (802) to register with basic identifying information, account security credentials (803), and accept terms and conditions (804). Email verification (805) confirms the account, which exists initially in a limited functionality state (806).

To enable full functionality, users must complete the identity verification process shown in FIG. 8. The system securely prompts (807) and redirects users to a trusted third-party provider (808) where they submit government-issued identification (809) and complete biometric confirmation through a selfie with liveness detection (810). Upon successful verification, the provider returns a cryptographically signed attestation (813) containing the verified information.

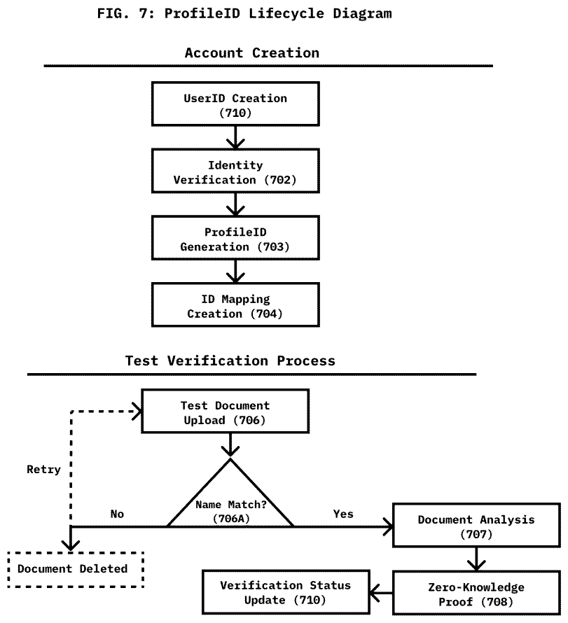

The system utilizes this attestation to create an immutable profile record containing the verified legal name, which becomes cryptographically sealed and cannot be changed without undergoing a formal name change process (717). As illustrated in FIG. 7, this process simultaneously generates a unique ProfileID through one-way hashing (703) with a server-side secret key and randomized salt, creating the mapping between UserID and ProfileID (704) for internal system operations.

After completing identity verification, users access the system through password authentication with required two-factor or optional biometric authentication for mobile apps. This enables users to initiate the test document verification process where all verification activities are associated with the ProfileID rather than the user's identity details that are tied to UserID.

The ProfileID lifecycle, as illustrated in FIG. 7, forms the backbone of this system's privacy-first architecture. Once created during identity verification, the ProfileID serves as the pseudonymous identifier which is used for all external system interactions. An example of this is during test submission and verification (706) when the ProfileID rather than UserID is associated with verification records. As shown in FIG. 7, client-side name matching (706A) ensures document ownership before any data is transmitted to the server, after which server-side processing (707) and zero-knowledge proof generation (708) lead to verification status updates (710) that maintain cryptographic separation between identity and health verification status.

The ProfileID remains constant throughout a user's lifecycle, with verification status updated with each new test submission. As depicted in FIG. 8, the only scenario that triggers creation of a new ProfileID is the formal name change process (717) mentioned earlier, which requires appropriate document and identity attestation before migrating verification history to the new ProfileID and deactivating the previous one. The verified legal name becomes immutable when full account access is enabled (816) and can only be changed through this formal process.

Each verification status has a predetermined validity period based on medical guidelines for testing frequency. The system tracks expiration dates, notifies users before expiration, implements grace periods to maintain streak continuity, and automatically expires verification statuses after the validity period.

### System Architecture

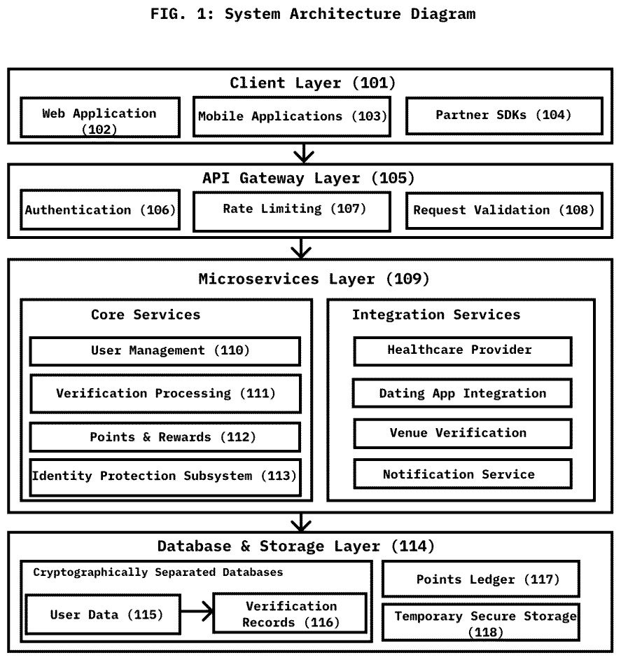

The system comprises multiple interconnected technical components that work together to enable privacy-preserving verification and behavioral incentivization, as illustrated in FIG. 1. The system includes:

Secure Upload Subsystem: Encrypted document transmission channel with client-side encryption and secure key management.

Verification Processing Engine: Advanced optical character recognition (OCR) and natural language processing (NLP) modules specifically optimized for medical document analysis, with integrated identity matching capabilities that verify document ownership while maintaining strict separation between verification status and personal identifiers after initial processing.

Zero-Knowledge Proof Generation Module: Integration system that utilizes third-party zkVM (Zero-Knowledge Virtual Machine) providers to create verifiable proofs without exposing underlying data.

Points Ledger and Transaction System: Immutable transaction record system with double-entry accounting for tracking user testing behavior.

Multi-dimensional Reward Algorithm Engine: Complex algorithmic system for calculating and awarding points based on various testing behaviors.

Achievement and Badge Management System: Progressive digital achievement system with unlockable display components.

Third-Party Authorization and Verification API: OAuth-based system for controlled sharing of verification status.

Secure Data Deletion Module: Cryptographic data destruction system implementing 800-88 Revision 1 wiping protocols.

As shown in FIG. 1, the system is implemented with a layered architecture. The Client Layer (101) includes web applications (102), mobile applications (103), and partner SDKs (104) that allow users and third-parties to interact with the system. The API Gateway Layer (105) provides authentication (106), rate limiting (107), and request validation (108) services. The Microservices Layer (109) includes the core services that implement the business logic, including User Management (110), Verification Processing (111), and Points & Rewards (112) services. The Identity Protection Subsystem (113) maintains strict separation between User IDs and Profile IDs. The Database & Storage Layer (114) stores user data (115), verification records (116), and the points ledger (117), with temporary secure storage (118) for documents during processing.

### Privacy-Preserving Verification Process

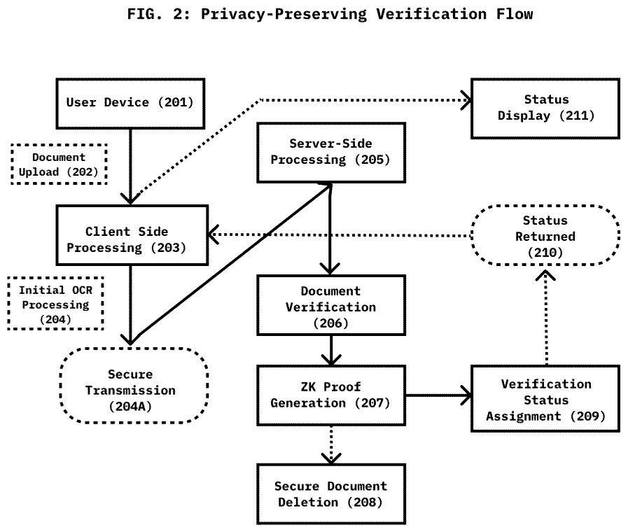

The invention implements a sophisticated multi-stage process for verification while ensuring complete privacy, as shown in FIG. 2. The process includes:

Secure Document Transmission: User initiates transmission of test documentation through an encrypted channel implementing TLS 1.3 with perfect forward secrecy. As shown in FIG. 2, the User Device (201) initiates the document upload (202) to the Client-Side Processing system (203).
Client-Side Document Processing: Initial OCR processing (204) occurs on the client device to extract minimally necessary information before transmission. During processing, the system confirms that the user's legal name on the test document matches their verified profile name. This one-time identity verification creates an immutable link between the user's profile and their verification status without exposing identity details in subsequent operations. After client-side processing is completed, the system securely transmits only necessary metadata to the server (204A).
Server-Side Verification: The Server-Side Processing system (205) performs advanced document analysis using specialized OCR and NLP algorithms trained specifically for medical document formats to extract:
(a) Test date information
(b) Testing facility identification
(c) Test type classification
   Document Authentication: The multi-factor verification system (206) analyzes document characteristics including:
(a) Format consistency with known laboratory templates
(b) Presence of expected security features
(c) Temporal consistency with claimed test date
(d) Structural validation of expected document elements

### Zero-Knowledge Proof Generation (207):

(a) Integration with third-party zkVM providers
(b) Creation of cryptographic proofs through the selected zkVM provider's API
(c) Proofs contains only verification status, pseudonymous profile ID, and test date, with specialized circuit optimizations to minimize computational complexity
(d) Proofs are mathematically verifiable without revealing underlying data
(e) Implementation of proof versioning for future compatibility with post-quantum cryptographic primitives
(f) Utilization of protocol-specific optimizations to minimize computational requirements while maintaining privacy guarantees

### Secure Document Destruction (208):

(a) Original documentation is permanently deleted using DOD-compliant wiping
(b) Multiple overwrite passes ensure data cannot be recovered
(c) Verification of deletion through cryptographic attestation

### Verification Status Assignment (209):

(a) User receives time-limited verification status
(b) Status includes cryptographic proof of verification (
c) Status has predetermined validity period based on test type and medical guidelines

The verification status is then returned (210) to the Client-Side Processing system (203) and ultimately displayed to the user on their User Device (201) as Status Display (211).

This process flow, as detailed in paragraphs [0075]-[0082], ensures that no sensitive medical information is stored or shared at any point in the verification process and significantly differs from conventional verification systems as it implements a zero-retention policy for medical test data.

### Database Schema for Points Ledger and Achievements Tracking

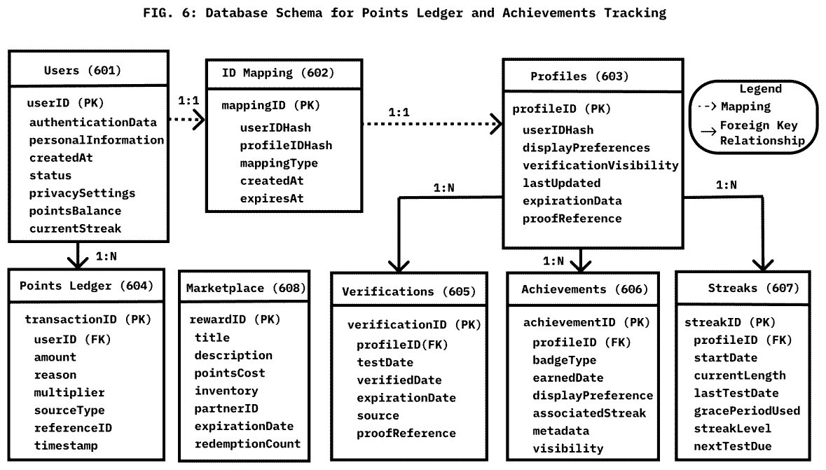

As shown in FIG. 6, the database architecture comprises several interconnected data models that work together to maintain privacy:

### Users Table (601):

(a) userID (Primary Key)—Securely stored internal identifier
(b) authenticationData—Credentials and security information
(c) personalInformation—Identifying information including the user's immutable name
(d) createdAt—Account creation timestamp
(e) status—Account status flag
(f) privacySettings—User-controlled privacy configuration
(g) pointsBalance—Current earned points
(h) currentStreak—Testing streak status

### Profiles Table (603):

(a) profileID (Primary Key)—Pseudonymous identifier used for external verification
(b) userID Hash—One-way cryptographic hash of associated userID
(c) displayPreferences—User-selected display settings
(d) verificationVisibility—Controls on what verification data is shared
(e) lastUpdated—Timestamp of last profile change
(f) expirationDate—When the verification expires
(g) proofReference—Reference to the zero-knowledge proof

### ID Mapping Table (602):

(a) mappingID (Primary Key)
(b) userID Hash—Secure one-way hash of the userID
(c) profileID Hash—Secure one-way hash of the profileID
(d) mappingType—Type of relationship between the IDs
(e) createdAt—When the mapping was established
(f) expiresAt—Optional expiration of the mapping

### Verifications Table (605):

(a) verificationID (Primary Key)
(b) profileID (Foreign Key)—References the pseudonymous profile
(c) testDate—Date of the verified test
(d) verifiedDate—When verification was completed
(e) expirationDate—When verification status expires
(f) source—Origin of verification (user upload, provider direct)
(g) proofReference—Reference to the zero-knowledge proof

### Points Ledger Table (604):

(a) transactionID (Primary Key)
(b) userID (Foreign Key)—For internal points tracking only
(c) amount—Point value of transaction
(d) reason—Categorized reason for point award
(e) multiplier—Any applicable point multipliers
(f) sourceType—Origin of points (test, streak, etc.)
(g) referenceID—Related verification or achievement
(h) timestamp—When points were awarded

### Achievements Table (606):

(a) achievementID (Primary Key)
(b) profileID (Foreign Key)—Links to profile for public achievements
(c) badgeType—Type of achievement earned
(d) earnedDate—When achievement was unlocked
(e) displayPreference—How badge is shown publicly
(f) associatedStreak—Related testing streak if applicable
(g) metadata—Additional achievement information
(h) visibility—Public/private status of achievement

### Streaks Table (607):

(a) streakID (Primary Key)
(b) profileID (Foreign Key)—Links to profile rather than user ID
(c) startDate—When streak began
(d) currentLength—Current streak duration
(e) lastTestDate—Date of most recent verified test
(f) gracePeriodUsed—Whether grace period has been applied
(g) streakLevel—Tier of streak achievement
(h) nextTestDue—Recommended date for next test

### Rewards Marketplace Table (608):

(a) rewardID (Primary Key)
(b) title—Reward name
(c) description—Reward details
(d) pointsCost—Points required to redeem
(e) inventory—A vailable quantity
(f) partnerID—Associated partner organization
(g) expirationDate—When reward offer expires
(h) redemptionCount—Times reward has been claimed

This privacy-preserving schema enables the incentive mechanisms detailed in paragraphs [0095]-[0113] while ensuring the Verifications Table stores only verification status and dates and associates records with pseudonymous profileIDs

This approach significantly differentiates this system from prior art solutions that store sensitive data centrally or in a distributed ledger as described in paragraphs [0009], [0010], and [0012].

### Points and Behavioral Incentive System

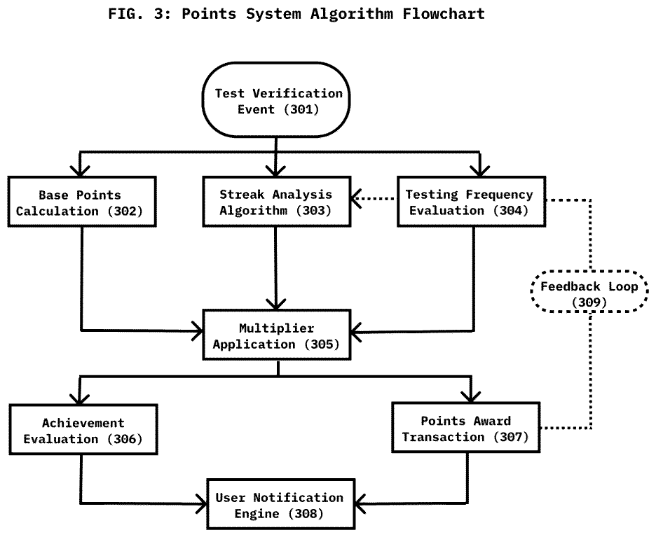

The invention implements a sophisticated algorithmic approach to incentivizing testing behavior, as depicted in FIG. 3. The algorithm begins with a Test Verification Event (301) and proceeds through various computational stages:

Base Testing Activity Rewards: The Base Points Calculation (302) module assigns points according to the following schedule:
(a) First Test Verification: 100 points+“First Step” badge
(b) Regular Test Upload (706): 50 points per verified test
(c) Provider-Verified Test: 75 points (tests received directly from healthcare providers)
(d) Comprehensive Panel Test: 25 bonus points for tests covering all major STIs
(e) Pre-Expiration Testing: 30 bonus points for uploading before previous test expires
   Testing Streak Mechanics: The Streak Analysis Algorithm (303) identifies testing consistency through:
(a) Implementation of temporal pattern recognition algorithms to identify testing consistency
(b) Progressive reward scale for streak maintenance:
   (i) 3 consecutive quarters: 100 bonus points+“Consistent Tester” badge (Bronze)
   (ii) 4 consecutive quarters: 150 bonus points+“Health Tracker” badge (Silver)
   (iii) 6 consecutive quarters: 250 bonus points+“Health Champion” badge (Gold)
   (iv) 8 consecutive quarters: 400 bonus points+“Ultimate Guardian” badge (Platinum)
   (v) Each additional quarter: +75 bonus points with logarithmic scaling
      Testing Frequency Evaluation (304): This module applies frequency recognition algorithms with multiplier application:
(a) Regular cadence (every 3-4 months): 1.2× point multiplier
(b) Improved cadence (every 2-3 months): 1.5× point multiplier
(c) Optimal cadence (every 1-2 months): 2× point multiplier

Multiplier Application (305): This module applies the calculated multipliers to the base point values.

Advanced Streaking Algorithms: These are implemented within the Streak Analysis Algorithm (303) and include:
(a) Grace period implementation for near-miss testing dates
(b) Streak protection mechanisms for temporary testing lapses
(c) Recovery acceleration for lapsed streaks
(d) Weighted algorithmic evaluation of testing patterns
   Multi-dimensional Achievement System: The Achievement Evaluation (306) module implements:
(a) Core progression achievement track with hierarchical badge structure
(b) Special achievement unlocks for specific behavioral patterns
(c) Limited-time achievement opportunities tied to health awareness events
(d) Public health campaign integration capabilities
(e) Progressive difficulty scaling for achievement unlocks
   Dynamic Point Management: The Points A ward Transaction (307) module implements:
(a) Double-entry accounting ledger for point transactions
(b) Point history with attribution and verification trail
(c) Point economy balancing algorithms
(d) Fraud detection systems for unusual point patterns
(e) Performance optimization for real-time point calculations

User Notification Engine (308): This module communicates achievements, point awards, and status updates to the user through configurable channels. The engine dynamically adjusts notification frequency and content based on user interaction patterns to prevent notification fatigue while maintaining optimal engagement.

As shown in FIG. 3, the system includes a feedback loop (309) from the Points A ward Transaction (307) back to the Streak Analysis Algorithm (303), creating a self-reinforcing system that continuously evaluates and rewards consistent testing behavior.

The point system and achievement mechanisms work together to address the psychological barriers to regular testing by applying principles of behavioral economics through computational methods. As prescribed by Skinner and Ferster (1957), the system achieves measurably increased testing frequency compared to conventional fixed-ratio approaches.

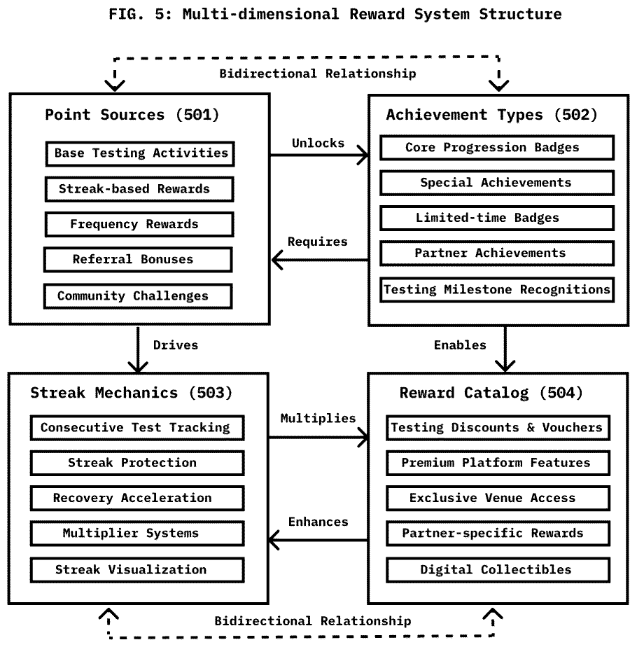

The reward system, as shown in FIG. 5, incorporates multiple interconnected components that work together to incentivize consistent testing behavior. FIG. 5 illustrates the components and their relationships:

### Point Sources (501):

(a) Base testing activities (first-time testing, regular testing)
(b) Streak-based rewards (consecutive quarterly testing)
(c) Frequency rewards (shorter intervals between tests)
(d) Referral bonuses (encouraging others to verify)
(e) Community challenges and events

### Achievement Types (502):

(a) Core progression badges with tiered recognition
(b) Special achievements for specific patterns
(c) Limited-time badges for health awareness events
(d) Partner achievements for integrated platforms
(e) Testing milestone recognitions

### Streak Mechanics (503):

(a) Consecutive test tracking with grace periods
(b) Streak protection for occasional lapses
(c) Recovery acceleration for lapsed streaks
(d) Multiplier systems for consistent behavior
(e) Streak visualization and progress tracking

### Reward Catalog (504):

(a) Testing discounts and vouchers
(b) Premium features on partner platforms
(c) Exclusive access to venues and events
(d) Partner-specific rewards
(e) Digital collectibles and recognition

As shown in FIG. 5, the system creates bidirectional relationships between Point Sources (501) and Achievement Types (502), as well as between Streak Mechanics (503) and Reward Catalog (504). These interconnections function as a self-reinforcing ecosystem where each component dynamically influences the others. Point accumulation from various sources directly unlocks achievements, while achievement progress simultaneously creates new point-earning opportunities through milestone bonuses. Similarly, streak maintenance increases access to higher-value rewards, while the visibility of premium rewards in the catalog incentivizes consistent streak maintenance. This dynamic, multi-pathway reward structure creates multiple engagement loops that function simultaneously, allowing users to derive motivation through their preferred incentive type while still benefiting from the full system.

These interconnections create a comprehensive incentive system that rewards users from multiple angles while maintaining their privacy throughout the process, directly addressing the “Lack of Motivation” barrier described in paragraph [0005].

By implementing a variable-ratio reinforcement schedule through the interconnected components shown in FIG. 5, the system creates stronger engagement patterns than fixed reward systems. This technical implementation optimizes testing frequency and consistency, transforming what would typically be sporadic testing behavior into sustainable, regular health practices that benefit both individual users and public health objectives.

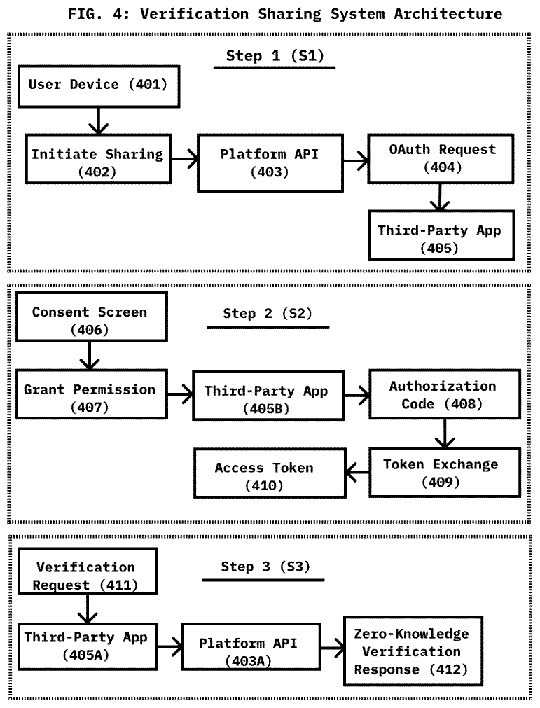

The invention implements a sophisticated system for securely sharing verification status while maintaining privacy, as illustrated in FIG. 4. The system includes the following components and processes:

Authorization Framework: The system implements an OAuth 2.0-based authorization flow as shown in FIG. 4, with:
(a) Fine-grained permission scopes
(b) User-controlled authorization flow with explicit consent
(c) Granular sharing permission management
(d) Per-platform sharing settings
(e) Revocation capabilities with immediate effect

As shown in FIG. 4, the User Device (401) initiates sharing (402) with the Platform API (403), which sends an OAuth Request (404) to the Third-Party App (405), completing the first step (S1). The User Device receives a Consent Screen (406) and provides Grant Permission (407). The Third-Party App (405B) then follows the standard OAuth flow, with an Authorization Code (408), Token Exchange (409), and Access Token (410), completing the second step (S2).

Verification Token System: The system creates and manages tokens with:
(a) Cryptographically signed tokens with tamper evidence
(b) Time-limited token validity
(c) Scope-limited information disclosure
(d) No personally identifiable information within tokens
(e) Verification without central authority dependence
   Access Control Mechanisms: The system implements:
(a) Hierarchical permission structure
(b) Temporal access limitations
(c) Usage quota enforcement
(d) Audit trail of verification checks
(e) Anomaly detection for unusual access patterns
   Verification Display Options: The system provides:
(a) Configurable badge display settings
(b) White-label integration capabilities
(c) Customizable verification UI components
(d) Progressive disclosure of verification details
(e) Verification status expiration indicators
   Verification Sharing Channels: The system enables sharing through:
(a) API-based verification for applications
(b) QR code generation for in-person verification
(c) Wallet pass integration (Apple/Google)
(d) Email verification attestation
(e) Webhook notification system for status changes

The sharing process continues to its final step with a Verification Request (411) from the Third-Party App (405A) to the Platform API (403A), which responds with a Zero-Knowledge Verification Response (412) that contains only the minimally necessary verification status information, completing step 3 (S3).

The verification sharing system creates a secure framework for sharing verification status with third parties without exposing any personal health information. Through the Identity

Protection Subsystem described in paragraph [0073], the system maintains cryptographic separation between User IDs and Profile IDs. This architecture ensures that even if verification data were compromised, it cannot be linked back to individual users, as partners only interact with pseudonymous identifiers.

The system implements a comprehensive partner integration framework that enables various types of organizations to connect with the verification platform while maintaining user privacy and security. The partner integration system includes:

Partner Portal: A dedicated web application that provides tools for API credential management, analytics dashboards, rewards management, verification monitoring, and documentation access.

Partner API: Secure endpoints that enable partners to integrate verification status sharing while maintaining privacy controls, including:
(a) Authentication and authorization using OAuth 2.0
(b) Verification status checking with minimal data exposure
(c) Batch verification capabilities for venue entry management
(d) Anonymous verification for insurance and public health partners
(e) Webhook notifications for status changes
   SDK Libraries: Pre-built software development kits for common platforms that simplify integration, including:
(a) Mobile SDK for iOS applications
(b) Mobile SDK for Android applications
(c) Web component library for browser-based applications
(d) Server-side libraries for backend integration

The partner integration system supports multiple partner types, each with specialized functionality:

Healthcare Provider Integration: Enabling clinics and testing centers to directly submit test verification with patient consent, including:
(a) Secure API for test date submission (no actual test results)
(b) Patient matching with consent verification using ProfileID
(c) Provider verification badging
(d) Analytics on testing frequency and patterns
(e) Custom rewards creation for patient incentives
   Dating Application Integration: Allowing dating platforms to display verification status badges without exposing medical information, including:
(a) Profile badge implementation
(b) Verification status API
(c) User filtering by verification status
(d) White-label verification UI components
(e) Verification analytics dashboard
   Venue and Event Integration: Providing verification checking capabilities for in-person events, including:
(a) QR code verification system
(b) Entry management tools
(c) Batch pre-verification capabilities
(d) Staff verification interface
(e) Venue-specific verification requirements
   Insurance Partner Integration: Enabling incentive programs while maintaining privacy, including:
(a) Anonymous verification checking
(b) Aggregated health trend access
(c) Incentive program management
(d) Policy holder verification analytics
(e) Compliance documentation

The partner integration system addresses the “Fragmented Ecosystem” challenge described in paragraph by providing standardized, secure methods for third-party integration. This technical approach significantly improves upon prior solutions by maintaining complete privacy while enabling seamless verification across multiple platforms and contexts.

### BEST MODE

The preferred embodiment integrates with third-party zkVM providers for zero-knowledge proofs, uses MongoDB for the points ledger, and employs a microservices architecture. This configuration balances scalability, modularity, and fault tolerance while maintaining privacy.

Zero-Knowledge Proof Integration: The system connects with zkVM providers through APIs, providing optimal security and performance for verification without exposing health data. Proof generation passes only relevant extracted data fields and a signed source hash. The system includes redundancy and recovery mechanisms ensuring continuous operation despite temporary component failures with the option to switch between zkVM providers if necessary.

Document Analysis System: A cascading pipeline combines client-side and cloud-based OCR with custom NLP models optimized for medical documents. This dual-processing approach first performs extraction on the user's device to minimize data transmission, including identity verification by matching the legal name on test records with the user's verified identity. Server-side algorithms identify test dates, provider information, and authenticity markers while aggressively filtering out diagnostic results and personal identifiers.

Secure Deletion Implementation: Media sanitization follows NIST SP 800-88 Rev. 1 guidelines. For SSDs, the system uses manufacturer-provided secure erase commands or cryptographic erasure; for magnetic media, single-pass overwrite. All methods include verification mechanisms to confirm successful deletion, maintaining compliance with data protection requirements.

Points Algorithm Implementation: MongoDB with specialized indexes enables efficient streak detection and real-time point calculations. The system architecture ensures data consistency and scalability to support growing user populations while maintaining performance.

Authorization Framework: OAuth 2.0 with JWT tokens (RS256) and rotating refresh tokens secures third-party integrations. Token payloads contain only pseudonymous identifiers and validation metadata, remaining revocable and verifiable without identity disclosure.

Partner Integration Implementation: RESTful API with comprehensive documentation, mobile SDKs, and web component libraries enable secure integration while maintaining privacy protections. All integration points implement appropriate security measures to prevent unauthorized access.

This preferred embodiment optimizes performance, security, and scalability while balancing technical efficiency with privacy protection.

### EXAMPLES

### Example 1: User Account Creation and Identity Verification

A new user initiates the account creation process, demonstrating the system's identity verification architecture that creates the foundation for privacy-preserving verification:

The user downloads the mobile application and creates an account with basic information.

To enable test verification, the user must complete identity verification:
(a) The system redirects to a trusted third-party identity verification provider
(b) The user submits government-issued identification and completes biometric confirmation
(c) The identity provider returns a cryptographically signed verification attestation
(d) The system extracts only the verified legal name and creates an immutable profile record
(e) This verified name becomes cryptographically sealed and cannot be changed without a formal review process

If identity verification fails:
(a) The system notifies the user with appropriate error guidance
(b) The account remains in a limited state with verification capabilities disabled
(c) Analytics log the failure reason without storing sensitive information
(d) The user may retry verification with fresh credentials

Upon successful verification:
(a) The system creates a separate ProfileID cryptographically derived from the UserID
(b) Zero-knowledge mappings are established between these identifiers
(c) The user gains access to document verification capabilities
(d) The system awards initial profile completion points

### Example 2: Dating Platform Integration

A dating application integrates with the system to provide verified health status indicators on user profiles:

The dating application registers as an authorized platform within the system through the Partner Portal.

Users of the dating application connect their profiles through an OAuth authorization flow, granting limited permissions to access only verification status.

When a user uploads and verifies a new test:
(a) The system processes the document through the privacy-preserving verification flow
(b) The verification status is updated in the user's profile
(c) The dating application receives a webhook notification of the status change
(d) The application displays a verification badge on the user's profile showing verification status without any medical details
(e) Users can filter potential matches based on verification status

If verification status changes or expires:
(a) The system generates a cryptographically signed revocation record
(b) A webhook notification with the new status is pushed to the dating platform
(c) The platform updates the user's badge status with appropriate visual indicators
(d) The change is logged in both systems without exposing the reason for revocation

Throughout this process, no actual test results are ever shared with the dating platform-only the binary verification status and expiration date.

### Example 3: Healthcare Provider Integration

A healthcare clinic implements direct integration with the system:

The clinic registers as an authorized provider within the system through the Partner Portal.

After receiving patient consent, the clinic submits test verification directly through the API:
(a) The clinic provides only test date and unique patient identifier
(b) No actual test results are transmitted
(c) The system employs a double-blind matching protocol where the patient identifier is hashed with a clinic-specific salt, then matched against similarly hashed user identifiers
(d) This cryptographic separation ensures the system cannot correlate identities without explicit consent
(e) The verification is marked as “provider-verified” with enhanced trust level
(f) The patient receives 75 points instead of the standard 50 points for user-verified tests

Patients can track their testing history and streak progress through the application, motivating return visits.

The clinic creates custom rewards redeemable through the marketplace, such as discounts on future testing services.

Aggregate, de-identified testing frequency analytics help the clinic optimize their outreach programs and testing promotions.

### Example 4: Venue Verification Implementation

An event venue implements the verification system for entry management:

The venue registers as an authorized verification partner through the Partner Portal.

Users generate time-limited QR codes containing their verification status.

Upon entry, venue staff scan QR codes to verify testing status without accessing any medical information.

The system performs verification checks.

Users with valid verification receive VIP access to exclusive areas, complimentary premium services, or special event access unavailable to non-verified attendees.

The venue receives aggregated, anonymized analytics on verification rates to optimize their health safety protocols and event planning.

### Example 5: Points-to-Rewards Conversion

A user accumulates points through regular testing and redeems them for rewards:

The user maintains a quarterly testing streak for one year, accumulating:
(a) 200 base points (50×4 tests)
(b) 100 bonus points (3-quarter streak)
(c) 150 bonus points (4-quarter streak)
(d) 60 bonus points (2 pre-expiration tests)
(e) Total: 510 points

The user browses the rewards marketplace and selects:
(a) Donation to AIDS Healthcare Foundation research program (200 points)
(b) One-month premium dating app subscription (300 points)

The system processes the redemption:
(a) Points are deducted from user balance
(b) Verification codes are generated
(c) Rewards are delivered through partner APIs
(d) Transaction is recorded in the points ledger reflecting a balance of 10 points

The user receives notification of successful redemption with instructions for using each reward and their remaining balance.

### Example 6: Mobile Application Implementation

The system includes native mobile applications for iOS and Android platforms that provide enhanced user experience:

The mobile application implements secure camera integration for streamlined document capture and upload.

Client-side OCR processing performs preliminary data extraction to minimize data transmission:
(a) The application applies trained machine learning models to identify sensitive data regions and explicitly filters out metadata that is not needed
(b) Only non-sensitive fields (date, provider name, etc.) are extracted locally to be sent for server-side processing
(c) Personal identifiers and test results are systematically redacted before transmission
(d) Hash-based content fingerprinting confirms document integrity without revealing content

The application includes built-in secure storage for verification status and achievement badges.

Push notifications alert users to upcoming verification expirations and achievement opportunities.

The application provides QR code generation for in-person verification at venues and events.

Biometric authentication (Face ID/Touch ID) optionally secures access to sensitive account functions.

### Example 7: At-Home Testing Kit Integration

A service providing at-home STI testing kits integrates with the system:

The at-home testing service registers as an authorized provider through the Partner Portal.

The user orders an at-home collection kit and provides consent for results to be shared with the verification system during the ordering process.

After receiving and processing the sample, the testing service submits verification through the API:
(a) The service provides only test date and unique order identifier.
(b) No actual test results are transmitted.
(c) The system matches the OrderID with the user's ProfileID.
(d) The verification is marked as “provider-verified” with enhanced trust level.
(e) The user receives 75 points as with other provider-verified tests.

### Example 8: Security Incident Response

The system effectively handles potential security threats:

A malicious actor attempts to manipulate verification status:
(a) The attacker attempts to modify a verification record by submitting altered test documentation
(b) The document analysis system detects inconsistencies in the document structure
(c) Zero-knowledge consistency checks identify timestamp anomalies
(d) The system flags the attempt and blocks the verification
(e) A nomaly detection algorithms update to recognize the specific pattern

An authorized partner experiences a data breach:
(a) The partner notifies the system of potential token compromise via the Partner Portal
(b) The system immediately invalidates all authorization tokens for that partner
(c) New signing keys are generated and distributed
(d) All affected users are notified via secure channels
(e) Zero user data is compromised since partner tokens contain only pseudonymous identifiers

The implementation examples provided in paragraphs [0141]-[0183] demonstrate the practical applications of the system across various contexts. These examples illustrate how the technical approach described in this invention effectively addresses the challenges outlined in paragraphs [0003]-[0007] while maintaining complete privacy and security, even during edge cases and security incidents.

### DETAILED COMPARISON WITH PRIOR ART

The following analysis compares the invention with cited references to demonstrate novelty and non-obviousness under 35 U.S.C. §§ 102 and 103:

Lee (2022, U.S. Pat. No. 11,238,454): This biometric payment system permanently stores templates on devices and lacks privacy protections for sensitive contexts. Unlike Lee, our invention implements zero-retention policies for personal identifiers, separates health status from identity, and uses zero-knowledge verification with behavioral reinforcement to maintain privacy.

Mahalingam (2020, U.S. Pat. No. 10,679,151): This centralized licensing system tracks digital content access without zero-knowledge proofs or privacy-preserving analytics. It's designed for content licensing rather than health data protection.

Zabar (2015, US 2015/0278824): While Zabar offers credential verification, its centralized platform creates a single point of failure. Our invention employs a distributed trust model with cryptographic separation between identity and credential data through a two-tier architecture. Unlike Zabar, we use zero-knowledge verification without exposing actual data and offer algorithmic incentivization with streak detection. Zabar's architecture would require fundamental redesign to achieve our cryptographic separation between user and test verification.

Felsher (2012, U.S. Pat. No. 8,316,237): This three-party communication system relies on an intermediary for encryption parameters. Our invention eliminates escrow requirements and key disclosure, instead enabling unidirectional verification through zkVM-generated proofs that are inherently unlinkable and revocable.

Johnson (2021, U.S. Pat. No. 10,972,275): While offering blockchain-based verification, Johnson's approach differs in six critical aspects:
(a) it relies on a centralized verification service rather than our trustless multi-party system;
(b) it primarily addresses authentication rather than selective disclosure from multiple issuers;
(c) it lacks temporal analysis and algorithmic incentivization with recovery acceleration;
(d) it omits our multi-stage document analysis pipeline;
(e) it requires biometric binding versus our pseudonymous identifiers; and
(f) it lacks our two-tier database architecture that ensures cryptographic separation between identity and verification.

Witchey (2019, U.S. Pat. No. 10,340,038): This healthcare blockchain creates chronological medical records, but differs fundamentally from our invention in these four ways:
(a) it stores actual health data rather than verification metadata;
(b) it prioritizes transparency over privacy;
(c) it requires continuous blockchain synchronization versus our ephemeral proofs; and
(d) it lacks our complete separation between identity and verification status.

Austin (2007, U.S. Pat. No. 7,246,067): This dating verification system centrally stores sensitive information, uses basic encryption, directly links verification to identity, lacks temporal analysis, and provides no incentivization mechanisms. Our invention eliminates central storage of sensitive data, uses zero-knowledge proofs, implements pseudonymous verification, and incorporates behavioral science-based incentives.

Bartley (2014, U.S. Pat. No. 8,719,056): While offering health behavior rewards, Bartley lacks privacy-preserving mechanisms, stores personal data, directly links identity to activities, and offers no data minimization. Our invention maintains cryptographic separation between identity and verification, implements zero-retention policies, and combines sophisticated streak detection with mathematically guaranteed privacy.

Our invention addresses significant technical gaps through the integration of five components absent from existing systems:
(a) A zero-knowledge proof system for health verification that processes test documents while revealing no protected health information;
(b) A behavioral incentive engine that analyzes temporal testing patterns to encourage adherence while maintaining privacy;
(c) A lightweight, mobile-first architecture with on-device pre-processing and minimal data transmission;
(d) Differential privacy implementation that ensures aggregate data utility while mathematically guaranteeing individual privacy; and
(e) An enhanced OAuth framework using pseudonymous identifiers that separate verification status from personal identity.

This system introduces several technical implementations not found in prior art: specialized zkVM integration for verifiable proofs from dynamic documents; temporal analysis with unlinkability preservation; document pre-processing with security feature detection; pseudonymous sharing via cryptographic blinding; and a modular reward architecture that incentivizes compliance while preserving privacy.

Even when considered in combination, the cited references fail to teach or suggest our integrated approach. Johnson lacks temporal analysis capabilities; Bartley lacks privacy protections; Zabar with Felsher would still require trusted intermediaries; and our document analysis pipeline represents an advancement not suggested by any combination. The references collectively teach away from our approach—Witchey prioritizes transparency over privacy, Felsher relies on intermediaries, and Bartley encourages broad data sharing. The technological disparities between these references would require substantial inventive effort to bridge, as evidenced by the absence of similar solutions in the intervening years.

The present invention provides a technical solution for health verification that addresses the limitations of existing approaches. By implementing verification protocols that confirm regular testing without revealing results, applying cryptographic techniques that prevent correlation between identity and health status, integrating behavioral science principles to support testing adherence, and enabling verification by authorized providers while preserving individual privacy, this invention offers a balanced approach to health verification. The technical

implementation described in paragraphs [0056]-[0140], combined with this comparative analysis, establishes the invention's novelty and non-obviousness, as no existing systems teach or suggest all claimed elements in their specific configuration.

### REFERENCES CITED

U.S. Patent Documents

| | | |
|---|---|---|
| U.S. Pat. No. 11,238,454 | January 2022 | Lee |
| U.S. Pat. No. 10,972,275 | April 2021 | Johnson et al. |
| U.S. Pat. No. 10,679,151 | June 2020 | Mahalingam et al. |
| U.S. Pat. No. 10,340,038 | July 2019 | Witchey |
| U.S. Pat. No. 2015/0278824 | October 2015 | Zabar |
| U.S. Pat. No. 8,719,056 | May 2014 | Bartley et al. |
| U.S. Pat. No. 8,316,237 | November 2012 | Felsher |
| U.S. Pat. No. 7,246,067 | July 2007 | Austin et al. |

### Non-Patent Literature

Ferster, C. B. and Skinner, B. F. “Schedules of Reinforcement.” Appleton-Century-Crofts, 1957.
Kissel, R., Regenscheid, A., Scholl, M., and Stine, K. “NIST Special Publication 800-88 Revision 1: Guidelines for Media Sanitization.” National Institute of Standards and Technology, Gaithersburg, MD, NIST Special Publication 800-88 Revision 1, December 2014.
Centers for Disease Control and Prevention (CDC). “Youth Access to Sexual Health Services.” 2017.
Centers for Disease Control and Prevention (CDC). “STI Prevalence, Incidence, and Cost Estimates.” 2018.
HIV.gov. “U.S. Statistics on HIV.” 2022.
Centers for Disease Control and Prevention (CDC). “STI Surveillance Report.” 2023.
ECFM G. “Electronic Portfolio of International Credentials (EPIC) Verification Services.” 2023.

1. A computer-implemented method for incentivizing health verification through a temporally-sensitive digital reward system, comprising:
(a) generating, by a computing device, cryptographic verification proofs for health verification events;
(b) recording, by the computing device, the cryptographic verification proofs with timestamps in a secure digital ledger implemented as a privacy-preserving distributed database with immutable transaction records;
(c) analyzing, by the computing device, temporal patterns between sequential verification events by calculating intervals between verifications;
(d) awarding, by the computing device, digital assets using a parameterized algorithm that:
(i) assigns differentiated base asset values based on verification source and type;
(ii) detects verification streaks by identifying consecutive verification events within defined time periods;
(iii) awards defined milestone bonuses at specific streak thresholds;
(iv) applies graduated frequency multipliers that increase reward magnitude as intervals between verifications decrease; and
(v) implements streak protection that maintains continuity despite minor deviations from optimal verification schedules; and
(e) validating, by the computing device, digital asset transactions through cryptographic verification using digital signatures and zero-knowledge proofs that prevent manipulation while maintaining privacy of the underlying health verification data.

2. The method of claim 1, wherein awarding digital assets comprises:
(a) assigning differentiated base asset values where provider-verified events receive a higher value than user-verified events;
(b) awarding progressively increasing milestone bonuses at defined consecutive verification intervals; and
(c) applying graduated frequency multipliers that increase as intervals between verifications decrease.

3. The method of claim 1, wherein implementing streak protection comprises:
(a) preserving streak continuity when verification resumes within a defined grace period of the recommended interval;
(b) applying a configurable secondary grace period; and
(c) calculating recovery acceleration factors for resumed verification after gaps using an adaptive temporal algorithm that weighs historical verification patterns.

4. A method for maintaining cryptographic separation between user identity and health verification status, comprising:
(a) implementing, by a computing device, a two-tier database architecture comprising:
(i) an identity tier that stores user authentication data encrypted with a first encryption key; and
(ii) a verification tier that stores only pseudonymous identifiers and verification status encrypted with a second encryption key;
(b) generating, by the computing device, a pseudonymous identifier by:
(i) receiving user identity data;
(ii) applying a one-way hashing function to the user identity data with a server-side secret key and randomized salt; and
(iii) storing only the resulting pseudonymous identifier in the verification tier with an associated time-limited expiration;
(c) enforcing, by the computing device, cryptographic separation through:
(i) strict separation between User IDs linked to actual identity and Profile IDs used as pseudonymous identifiers for verification sharing; and
(ii) association of verification records exclusively with pseudonymous profileIDs rather than identity details.

5. A method for securely sharing health verification status with third parties, comprising:
(a) implementing, by a computing device, an OAuth 2.0-based authorization flow with user-controlled consent;
(b) generating, by the computing device, cryptographically signed, time-limited verification tokens that contain no personally identifiable information;
(c) enabling, by the computing device, verification sharing through multiple channels including API-based verification, QR code generation, and wallet pass integration; and
(d) maintaining cryptographic separation between User IDs and Profile IDs to ensure verification data cannot be linked back to individual users.

6. A method for privacy-preserving extraction of verification metadata from health documentation, comprising:
(a) receiving, by a computing device, health documentation through a secure transmission channel with client-side encryption and secure key management;
(b) processing, by the computing device, the health documentation through a multi-stage document analysis pipeline that:
(i) performs client-side preliminary extraction to reduce data transmission;
(ii) applies server-side optical character recognition optimized for medical documents;
(iii) employs natural language processing models trained on medical documentation; and
(iv) utilizes entity classification algorithms to distinguish verification metadata from sensitive health information;
(c) extracting, by the computing device, only verification metadata comprising:
(i) relevant date information;
(ii) issuing facility or provider identifier; and
(iii) document type classification;
(d) filtering, by the computing device, all sensitive health information using classification algorithms with high accuracy; and
(e) securely deleting, by the computing device, the original documentation after extraction.

7. The method of claim 6, wherein the multi-stage document analysis pipeline comprises:
(a) client-side preprocessing that identifies document type and extracts only necessary fields;
(b) server-side processing that identifies test dates, provider information, and authenticity markers; and
(c) client-side name matching to ensure document ownership before data transmission.

8. The method of claim 6, wherein filtering sensitive health information comprises:
(a) applying trained machine learning models to identify sensitive data regions; and
(b) systematically redacting personal identifiers and test results before transmission.

9. A system for privacy-preserving health verification with digital incentives, comprising:
(a) at least one processor; and
(b) memory storing instructions that, when executed by the at least one processor, cause the system to:
(i) extract verification metadata from health documentation using a multi-stage document analysis pipeline that performs client-side preliminary extraction, applies server-side optical character recognition, employs natural language processing models, and utilizes entity classification algorithms;
(ii) implement a two-tier database architecture comprising an identity tier and a verification tier with cryptographic separation;
(iii) award digital assets using a parameterized algorithm that assigns differentiated base asset values, detects verification streaks, awards milestone bonuses, applies graduated frequency multipliers, and implements streak protection;
(iv) enable secure verification sharing through OAuth 2.0-based authorization flow, cryptographically signed tokens, and multiple sharing channels;
(v) integrate the extraction, cryptographic separation, incentivization, and sharing subsystems while maintaining functional separation; and
(vi) implement error handling protocols that maintain system integrity during failures.

10. A non-transitory computer-readable medium storing instructions that, when executed by at least one processor, cause the processor to perform a method comprising:
(a) extracting verification metadata from health documentation using a multi-stage document analysis pipeline that filters sensitive information while preserving verification metadata;
(b) creating a cryptographic separation between user identity and verification status by generating a pseudonymous identifier through one-way hashing of user identity data with a server-side secret key and cryptographic salt; and
(c) awarding digital assets based on temporal patterns between verification events using a parameterized algorithm that implements verification streaks and graduated reward multipliers with logarithmic scaling to maximize long-term engagement.
